(19) United States
(12) Patent Application Publication
(10) Pub. No.: US 2025/0371557 A1
(43) Pub. Date: Dec. 4, 2025

(54) DATA PROCESS FOR ENVIRONMENTAL SOCIAL AND GOVERNANCE COMPLIANCE

(71) Applicant: MASTERCARD INTERNATIONAL INCORPORATED, PURCHASE, NY (US)

(72) Inventors: Steven EARHART, Kirkwood, MO (US); Erik LUEDERS, Webster Groves, MO (US); Andrew STANOWSKI, Dardenne Prairie, MO (US)

(21) Appl. No.: 19/222,828

(22) Filed: May 29, 2025

Related U.S. Application Data
(60) Provisional application No. 63/654,880, filed on May 31, 2024.

(51) Int. Cl. G06Q 30/018; G06Q 50/06

(52) U.S. Cl. CPC G06Q 30/018; G06Q 50/06

(57) ABSTRACT

A computerized method for environmental, social, and governance (ESG) compliance of assets of a data center is provided. A list of assets of a data center is obtained and energy consumption by the assets during a time period is measured. Total energy consumption of the data center during the time period is received. The energy consumption by the assets is compared with the total energy consumption of the data center. Based on the comparison, if it is determined that the total energy consumption of the data center is more than the energy consumption by the assets in the list of assets, an asset of the data center not in the list of assets is identified. An action, comprising decommissioning the identified asset, virtualizing the identified asset, and/or configuring the identified asset in balanced mode, on the identified asset of the data center is automatically performed.

### BACKGROUND

A data center includes assets such as servers, storage devices, network equipment, rack power distribution units (PDU), and applications hosted on the servers. The data centers consume a lot of energy and reducing carbon footprint is a primary goal for meeting environmental, social, and governance (ESG) compliance requirements by an organization. While existing asset management solutions for data centers maintain an inventory of assets, some assets may not be accounted for in the inventory, some assets may be underutilized or overutilized, or some assets may be cause of significant carbon emissions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An example computerized method for environmental, social, and governance (ESG) compliance of assets of a data center is described. A list of assets of a data center is obtained and energy consumption by the assets during a time period is measured. Total energy consumption of the data center during the time period is received. The energy consumption by the assets is compared with the total energy consumption of the data center. Based on the comparison, if it is determined that the total energy consumption of the data center is more than the energy consumption by the assets in the list of assets, an asset of the data center not in the list of assets is identified. An action, comprising decommissioning the identified asset, virtualizing the identified asset, and/or configuring the identified asset in balanced mode, on the identified asset of the data center is automatically performed.

### BRIEF DESCRIPTION OF THE DRAWINGS

The present description will be better understood from the following detailed description read considering the accompanying drawings, wherein:

FIG. 1 is a block diagram illustrating an example system configured for implementing a data process for environmental, social, and governance (ESG) compliance of assets of a data center;

FIG. 2 is a block diagram illustrating an example system configured for implementing a data process for ESG compliance of assets of a data center;

FIG. 3 is a block diagram illustrating an example system configured for implementing a data process for ESG compliance of assets of a data center;

FIG. 4 is a flowchart illustrating an example method for controlling assets of a data center for ESG compliance;

FIG. 5 is a flowchart illustrating an example method for controlling assets of a data center for ESG compliance;

FIG. 6 illustrates an example user interface for displaying monthly view of energy of the assets in a data center;

FIG. 7 illustrates an example user interface for displaying top carbon emitters and for identifying underutilized servers;

FIG. 8 illustrates an example user interface for displaying number of underutilized servers;

FIG. 9 illustrates an example user interface for inputting program level details;

FIG. 10 illustrates an example user interface for displaying underlying data used for energy, carbon emitted, and utilization by devices;

FIG. 11 illustrates an example user interface for displaying underlying data used for controlling assets of a data center for ESG compliance; and

FIG. 12 illustrates an example computing apparatus as a functional block diagram.

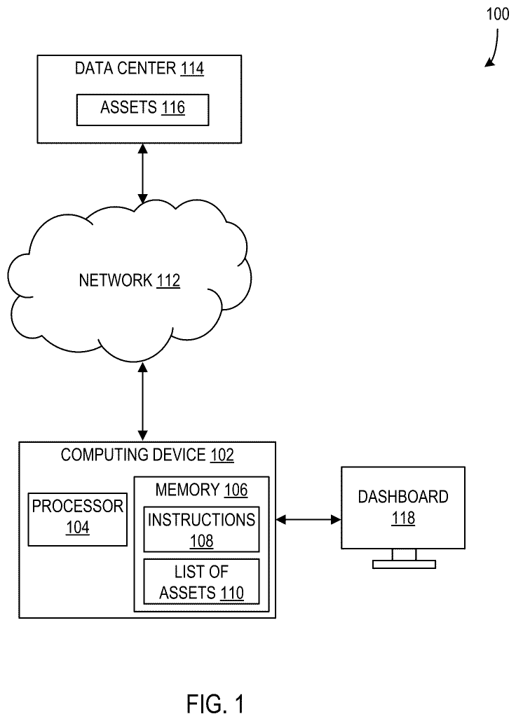

Corresponding reference characters indicate corresponding parts throughout the drawings. In FIGS. 1 to 12, the systems are illustrated as schematic drawings. The drawings may not be to scale. Any of the figures may be combined into a single example or embodiment.

### DETAILED DESCRIPTION

Aspects of the disclosure include systems and methods configured to address technical issues associated with environmental, social, and governance (ESG) compliance of assets in data centers. Data associated with assets in a data center data center is obtained and energy consumption by the assets during a time period is measured and analyzed. Total energy consumption of the data center during the time period is received. Differences between the total energy consumption and the consumption of the assets are identified and, if it is determined that the total energy consumption of the data center is more than the energy consumption by the assets in the list of assets, an asset of the data center not in the original list of assets is identified. An action, comprising decommissioning the identified asset, virtualizing the identified asset, and/or configuring the identified asset in balanced mode, on the identified asset of the data center is automatically performed.

In some examples, a computerized system and method obtains a list of assets of a data center and measures energy consumption by assets in the list of assets during a time period. Total energy consumption of the data center during the time period is received (e.g., from an energy provider/supplier). The energy consumption by the assets in the list of assets is compared with the total energy consumption of the data center during the time period. Based on the comparison, if it is determined that the total energy consumption of the data center is more than the energy consumption by the assets in the list of assets (e.g., by a threshold value such as 50 KWh), an asset of the data center not in the list of assets is identified. An action on the identified asset of the data center is automatically performed. The action comprises one or more of decommissioning the identified asset, virtualizing the identified asset, and/or configuring the identified asset in balanced mode. This process reduces or eliminates wasted energy resource usage and thereby improves the energy efficiency of the operations of the data center. Further, the process automatically addresses configuration issues or other technical issues that may jeopardize ESG compliance of the data center, reducing the need for manual analysis and/or freeing up people and system resources for performing other tasks.

In some embodiments of the disclosure, the energy consumption by each of the assets is measured via one of an actual energy consumption, calculated energy consumption, estimated energy consumption, specification sheet of the asset, and an average of energy consumption of assets other than the asset. The actual energy consumption is measured from a platform tool on a regular, automated, ongoing basis. The calculated energy consumption is measured manually from a platform tool, but only a small sample that is extrapolated (e.g., 1 week of actual data is extrapolated to 4 weeks per month calculated). The estimated energy consumption is measured by applying actual energy consumption or calculated energy consumption for one asset as an estimate for similar assets for which actual energy consumption or calculated energy consumption data is not available. A specification sheet of the asset with a “max-rating” or “typical” values is provided by the vendor which may be used for measuring energy consumption of that asset (e.g., 70% of Max-Rating may be taken as energy consumption by the asset). In some examples, an average of energy consumption of assets other than the asset is applied to the asset for which little or no energy consumption data is available. In some other examples, when actual energy consumption data is not available for an asset, machine learning techniques are used to approximate the energy consumption for the asset. The use of and combination of a variety of energy consumption measurement techniques enables the described processes to be applied to many different types of data centers with diverse assets associated therewith with little or no reconfiguration.

In some examples, a computerized system and method obtains a list of assets of a data center and measures energy consumption by each asset in the list of assets. A geographical location of each asset in the list of assets is identified. Emission factors are used to “enrich” the measured energy consumption data. For each asset, scope 2 carbon dioxide emission (CO2e) is determined by combining emission factors associated with the identified geographical location and the monitored energy consumption. A cost for the determined scope 2 CO2e is determined for each asset. An asset in the list of assets having the determined cost more than a threshold value is identified. An action on the identified asset of the data center is automatically performed. The action comprises one or more of decommissioning the identified asset, virtualizing the identified asset, and configuring the identified asset in balanced mode.

Further, in some examples, the disclosed system and method provide a technical effect by offering an integrated approach to enhance environmental, social, and governance (ESG) compliance within data centers through the management and optimization of data center assets. The system enables accurate asset inventory and effective energy monitoring, allowing for comprehensive tracking of energy consumption across all data center components. By identifying discrepancies between total data center energy usage and the aggregated consumption of documented assets, the system facilitates the identification and optimization of underutilized or redundant assets.

Additionally, or alternatively, the described process further achieves the technical effect of automating corrective actions such as decommissioning, virtualizing, or reconfiguring the assets, resulting in optimized energy efficiency and reduced carbon emissions. The integration of geographical location data with regional emission factors provides accurate carbon emission calculations, further empowering users with valuable insights into asset performance and environmental impact.

In some examples, by leveraging machine learning techniques and data modeling, the described systems and methods refine energy efficiency strategies, leading to continuous improvements in ESG compliance methodologies. The combination of dynamic scalability and flexibility allows the system to accommodate diverse data center configurations and measurement techniques, 1 significantly improving adaptability across various environments. The inclusive user interface facilitates user interaction and empowers customization, enabling data center operators to make informed decisions based on comprehensive energy consumption trends and cost analyses. This contributes to a systematic reduction in energy waste and promotes efficient data center operations aligned with ESG objectives.

FIG. 1 is a block diagram illustrating an example system 100 configured for implementing a data process for environmental, social, and governance (ESG) compliance of assets of a data center. In some examples, the system 100 includes a computing device 102 that comprises a processor 104 and a memory 106. The memory 106 stores instructions 108 that upon execution by the processor 104 obtain, via network 112, list of assets 110 of a data center 114 comprising the assets 116. Assets 116 of the data center 114 comprise servers, storage devices, network equipment, rack power distribution units (PDU), applications hosted on the servers, and the like.

The list of assets 110 is analyzed to identify assets that may be causes of carbon emissions above a threshold level or that may be underutilized. In some examples, an asset not in the list of assets 110 is identified as underutilized or a cause of carbon emissions above the threshold level. Results of the analysis are presented on a dashboard 118 to a user of the computing device 102. An action is performed (automatically or upon input from the user) on the identified asset 116 of the data center 114. The action on the identified asset 116 advantageously optimizes the availability, utilization, and efficiency of the data center 114.

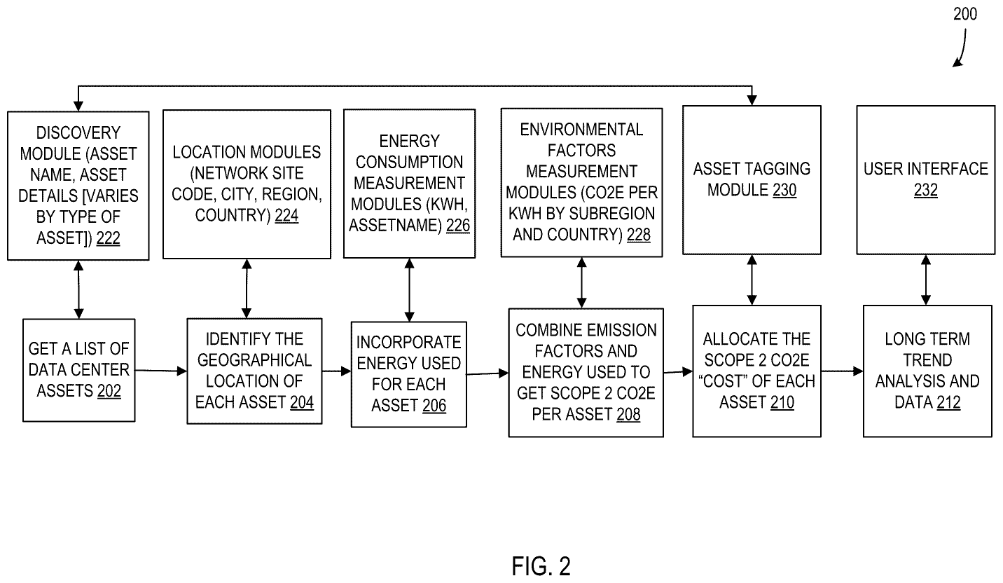

FIG. 2 is a block diagram illustrating an example system 200 configured for implementing a data process for ESG compliance of assets of a data center. At 202 a list of data center assets is received from a discovery module 222. The list of data center assets is received from the discovery module 222 periodically (e.g., weekly) in an automated way via application programming interface (API). The discovery module provides Asset Name and Asset Details that may vary by the type of asset (e.g., storage, network etc.). In an example, the discovery module 222 provides details (e.g., Hostname, Serial Number, and Datacenter) of an asset as listed below in Table 1:

TABLE 1

| | |
|---|---|
| Hostname | Stl2esxdn01 |
| Serial Number | CDS7KH2 |
| Datacenter | St. Louis (STL) |

At 204, the geographical location of each asset is identified using location modules 224 (such as IP address management (IPAM), Network Sites report, manual mapping (Artificial Intelligence for Information Technology Operations (AIOps)), etc.). The location modules 224 provide information such as Network Site Code, City, Region, Country, Electric Subregion, etc. of each asset. In an example, the location modules 224 provide details of an asset as listed below in Table 2:

TABLE 2

| | |
|---|---|
| Network Site Code | St. Louis (STL) |
| City | O'Fallon |
| Country | United States |
| Electric Subregion | State Emergency Response Commission |
| | (SERC) Midwest (SRMW) |

At 206, energy used for each asset is incorporated from energy consumption measurement modules 226 that provide energy consumption by each asset in kilo watt hours (KWh). The energy consumption measurement modules 226 may be third party tools and/or scripts developed using vendor provided APIs for assets, and device specification provided by the hardware manufacturer. The energy consumption measurement modules 226 provide periodic energy consumption information (e.g., monthly) in KWh of each asset. In an example, the energy consumption measurement modules 226 provide details of an asset as listed below in Table 3:

TABLE 3

| | |
|---|---|
| Monthly Energy In KWh | 122.26500000000001 |

At 208, emission factors and energy used are combined to get Scope 2 carbon dioxide emissions (CO2e) per asset. The emission factors are obtained from environmental factors measurement modules 228 such as an International Energy Agency (IEA) environmental factors module that provides CO2e per KWh by Country and a regional environmental factors module (such as eGRID United States environmental factors) that provides CO2e per KWh by Subregion. In an example, the environmental factors measurement modules 228 provide details of an asset as listed below in Table 4:

TABLE 4

| | |
|---|---|
| kg of CO2e per KWh | 0.7 |
| Carbon Emitted | 86 |

At 210, the Scope 2 CO2e cost is allocated to each asset using technology business management (TBM). Some of these assets may or may not be in the list of data center assets received at 202. This “cost” is used by asset tagging module 230 for tagging the assets accurately so that the discovery modules 222 provide accurate tagged details of all assets of the data center in subsequent iterations. In an example, the asset tagging module 230 tags the asset (e.g., using tags such as Hostname, Serial Number, Carbon Emitted values, Start Period, and/or End Period) as listed below in Table 5:

TABLE 5

| | |
|---|---|
| Hostname | Stl2esxdn01 |
| Serial Number | CDS7KH2 |
| Carbon Emitted | 86 |
| Start Period | 2023 Jul. 1 |
| End Period | 2023 Aug. 1 |

At 212, long term trend analysis and data for the assets is presented to a user via user interface 232. In some examples, the asset tagging module 230 is initiated when the user provides an input in the user interface 232 for tagging a particular asset or a group of assets. In some examples, the user selects an asset from the assets presented to the user via the user interface 232 and the action is automatically performed on the selected asset.

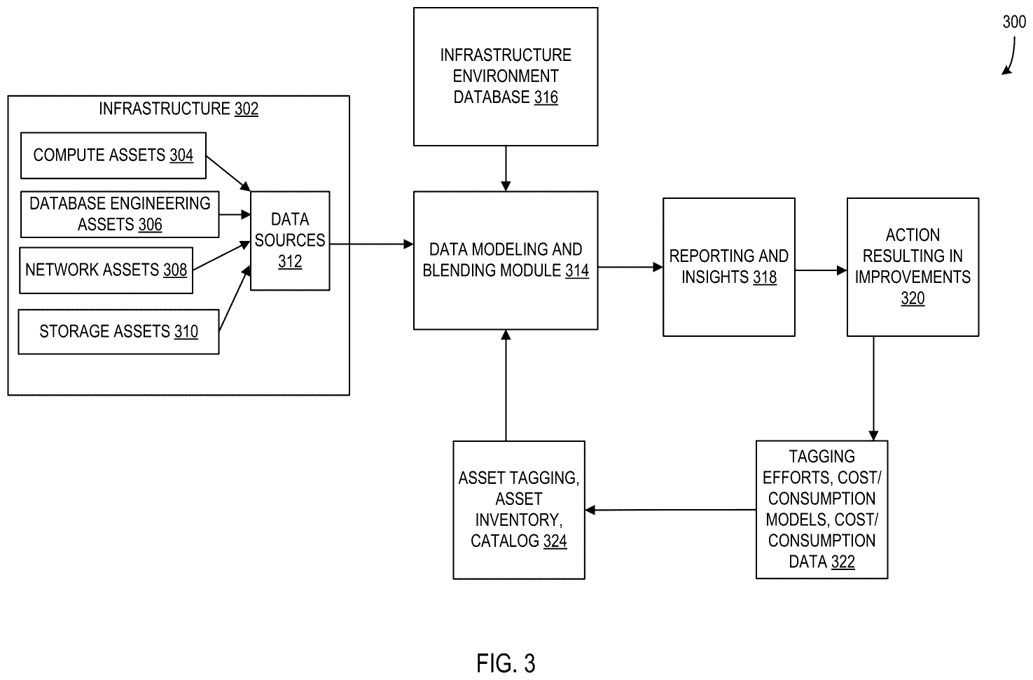

FIG. 3 is a block diagram illustrating an example system 300 configured for implementing a data process for ESG compliance of assets of a data center. An infrastructure 302 (such as a data center) includes compute assets 304, database engineering assets 306, network assets 308 (e.g., network equipment such as switches, routers, firewalls, and the like), and storage assets 310 (such as corporate devices, m365, and the like). Information about the assets 304-310 is obtained by the data sources 312. The data sources 312 may be specific to the vendor of an asset, provided by a third party, or a specifically programmed data source for obtaining information about the assets 304-310.

Some exemplary data sources 312 provide (1) asset inventory and configuration details, (2) power and/or CPU utilization for virtualized hosts, (3) power and/or CPU utilization for blades, (4) power and/or CPU utilization for mainframe devices (e.g., International Business Machines (IBM) Hardware Management Console (HMC)), (5) network site code to City/Country, (6) energy per Exadata node (e.g., Integrated Lights Out Manager (ILOM)—ORACLE Exadata), (7) energy per million instructions per second (MIP), Internet Protocol (IP) address to network site code, (8) CPU/Memory utilization for distributed compute tasks (e.g., Scripts and Technical Addons), (9) asset inventory, (10) approximate energy per device model (e.g., Network Specification Sheet), (11) CO2e/KWh per country (e.g., IEA Country emissions factors), (12) CO2e/KWh per US subregion (e.g., eGRID emission factors), and the like to data modeling and blending module 314.

The data sources 312 provide information about the assets 304-310 to data modeling and blending module 314. The data modeling and blending module 314 also receives information from the information environment database 316 that maintains information about the data center engineering/facilities (such as colocation data centers, Smart PDUs, Owned data centers, and the like), data sources (such as annual sustainability reports (e.g., renewable energy), colocation annual sustainability reports (e.g., renewable energy), colocation data center service level agreements (SLAs) (e.g., meter reading, IT KWh, Solar Revenue Puts), facilities data center tracker (e.g., meter reading, IT KWh, Solar revenue Puts), emissions data provider for cloud computing use, and the like, and cloud service providers.

The data modeling and blending module 314 analyzes the energy consumption of the assets and data center as received/obtained from the data sources 312 and infrastructure environment database 316 to generate reporting and insights 318 into the energy consumption by the assets of the data center. Various types of reports and insights may be generated such as carbon efficiency of market facing products, energy and carbon showback per product, energy and carbon showback per platform, forecasting and A/B scenario testing (e.g., for selecting site of an asset between location A and B), regulatory reporting, and the like. When an action 320 is performed on an identified asset, such action 320 results in improvements (e.g., improved planning, improved platform utilization and efficiency, improved data quality, improved sustainability and project prioritization, and the like) of the infrastructure 302.

A user interacts with the generated reports and insights 318 and the resulting improvements from the actions 320 (e.g., via the dashboard 118 or the user interface 232) for tagging the assets, streamlining the cost/consumption models, and/or streamlining the cost/consumption data at 322. The user interaction at 322 results in asset tagging, asset inventory and catalog generation at 324 which is fed back to the data modeling and blending module 314 for improving the functionality of the data modeling and blending module 314 using machine learning techniques.

In some examples, the data sources 312 and/or infrastructure environment database 316 may provide measurements such as (1) 4000 bare-metal servers are responsible for 700 metric ton (mT) of carbon emission per month, (2) 1100 servers having technical asset tag for decision making (e.g., tagged in an earlier iteration by data modeling and blending module 314) are responsible for 145 mT of carbon emission per month, and (3) 188 servers have CPU utilization data of 0-5%, 132 servers have CPU utilization data of 5-15%, and 3100 servers had CPU utilization data less than 35% etc.

In some examples, the data modeling and blending module 314 determines the percentage of time each process is running. For example, a job running for 0.3% of the time is taking 46% of a single core of CPU. Based on this information that the job is not running for a significant amount of time, the data modeling and blending module 314 may recommend virtualizing the server running this job, adding other jobs to this server, or decommissioning this server after migrating the job to some other server. As another example, if a running server is lagging in tagged data, environmental data, and has low utilization data, then the data modeling and blending module 314 may recommend decommissioning the server. In some examples, decommissioning a server is automatically performed if the job running on this server has not been accessed for a predetermined time period (e.g., 1 year).

In some examples, the data modeling and blending module 314 may recommend various pathways for the asset (e.g., decommissioning, virtualizing, changing to balanced mode, adding business value or consolidate, providing utilization metrics, doing nothing, obtaining suggestions from a subject matter expert (SME), or tech refresh/rightsized bare-metal) as listed below in Table 6:

TABLE 6

| Pathway | Environmental Value |
|---|---|
| Decommission | Best |
| Virtualize | Great |
| Change to Balanced Mode | Good |
| Add business value/consolidate | Neutral |
| Provide utilization metrics | Neutral |
| Do nothing | Bad/Not aligned with the |
| | organization's NetZero goals |
| SME suggestion | Re-architect |
| Tech Refresh/Rightsized | Negative |
| baremetal | For Scope 3/Scope 2 |

From the pathways in Table 6, decommissioning an asset is considered to be the best because it frees up significant resources and tech refresh or rightsizing baremetal is considered to be the worst because it requires significant resources. The pathway of a subject matter expert (SME) suggestion asks an SME to re-architect the system to produce a better solution. Even though the pathway of SME suggestion also requires resources, it is still better than a complete tech refresh or rightsizing.

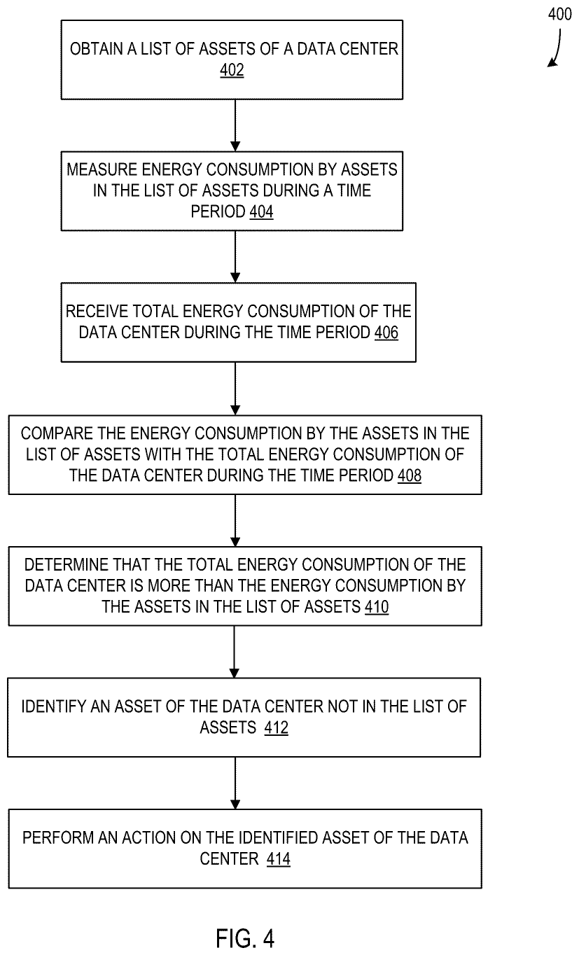

FIG. 4 is a flowchart illustrating an example method 400 for controlling assets of a data center for ESG compliance. At 402, a list of assets of a data center is obtained. At 404, energy consumption by assets in the list of assets during a time period is measured (e.g., using the data sources 312). At 406, total energy consumption of the data center during the time period is received (e.g., from an energy provider/supplier that may be part of the infrastructure environment database 316). At 408, the energy consumption by the assets in the list of assets is compared with the total energy consumption of the data center during the time period. At 410, it is determined that the total energy consumption of the data center is more than the energy consumption by the assets in the list of assets based on the comparison. In some examples, when the total energy consumption of the data center is more than the energy consumption by the assets by a threshold value such as 50 KWh, it indicates that there are some assets in the data center consuming significant amounts of energy and these assets are not in the list of assets. In other examples, other threshold values are used without departing from the description.

Upon determining that the total energy consumption of the data center is more than the energy consumption by the assets in the list of assets, an asset of the data center not in the list of assets is identified at 412. At 414, an action on the identified asset of the data center is automatically performed. The action comprises one or more of decommissioning the identified asset, virtualizing the identified asset, and configuring the identified asset in balanced mode.

In some examples, the action on the identified asset is automatically performed upon determining that the identified asset satisfies the criterion. In some examples, the criterion comprises one of determining that the energy consumption by the identified asset is more than a threshold value (e.g., a first threshold value such as 50 KWh) or determining that the energy consumption by the identified asset is less than a threshold value (e.g., a second threshold value such as 0.5 KWh). The threshold value may be in percentage of the total energy consumption (e.g., 10% for first threshold and 0.1% for second threshold). In some examples, the criterion comprises determining that the identified asset is a virtual machine, determining that the identified asset is not running a database, or both.

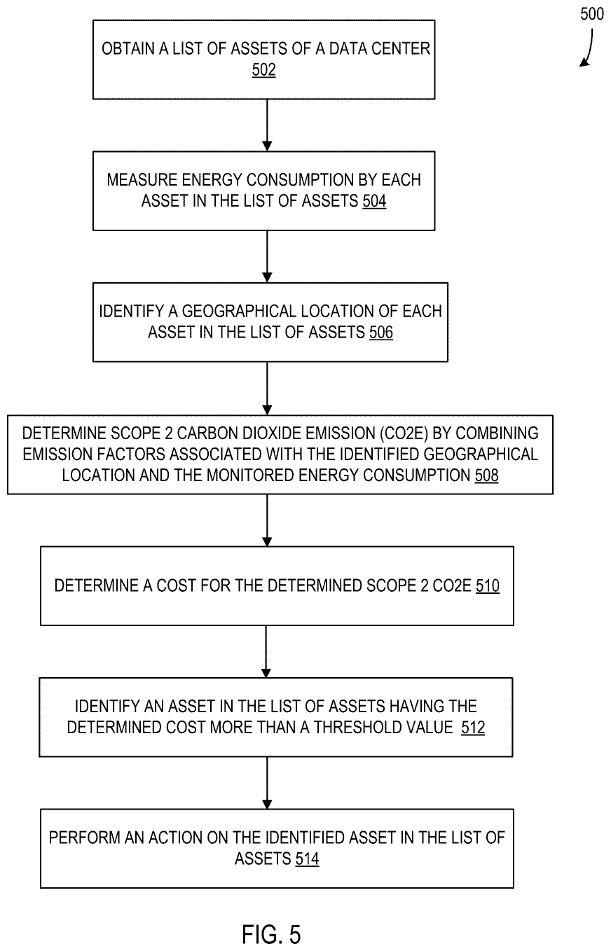

FIG. 5 is a flowchart illustrating an example method 500 for controlling assets of a data center for ESG compliance. At 502, a list of assets of a data center is obtained. At 504, energy consumption by assets in the list of assets during a time period is measured (e.g., using the data sources 312). At 506, a geographical location of each asset in the list of assets is identified. At 508, scope 2 carbon dioxide emission (CO2e) is determined by combining emission factors associated with the identified geographical location and the monitored energy consumption for each asset. At 510, a cost for the determined scope 2 CO2e is determined for each asset. At 512, an asset in the list of assets having the determined cost more than a threshold value is identified. At 514, an action on the identified asset of the data center is automatically performed.

In some examples, a trend analysis of the cost associated with each asset is presented in a user interface. The trend analysis comprises historical cost, current cost, and future cost associated with each asset. An input from a user in the user interface is received to identify an underutilized asset in the data center (e.g., consuming less than 0.1% of CPU resources). The action may be automatically performed on the identified underutilized asset.

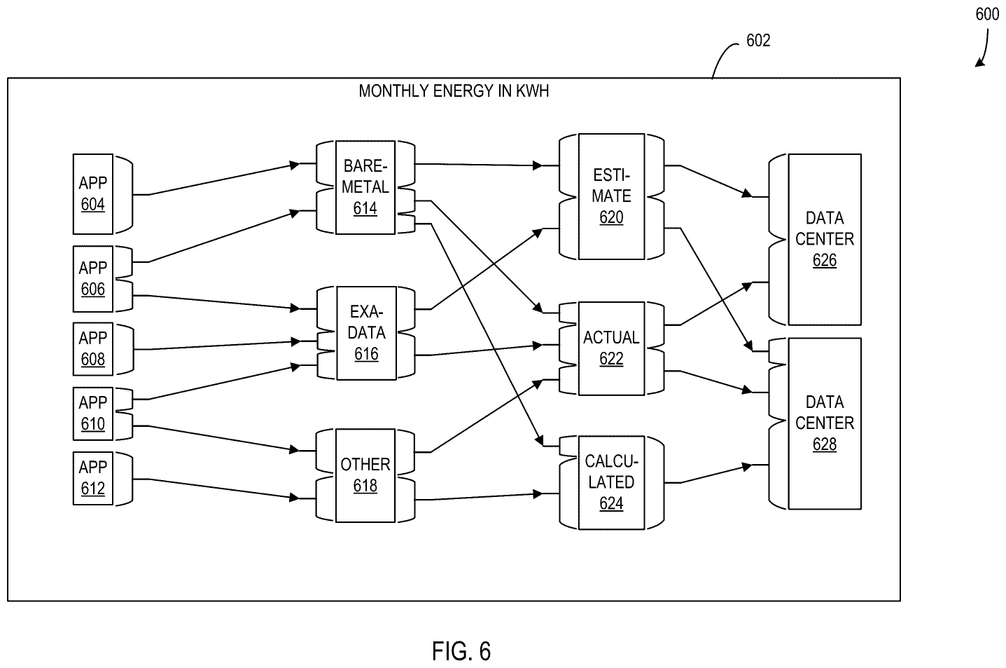

FIG. 6 illustrates an example user interface 600 for displaying monthly view 602 of energy of the assets in a data center such as data center 114. In an example, a server running two applications may be listed twice if both the applications are among the top carbon emitters or energy consumers of the data center. The monthly view 602 includes a set of apps 604, 606, 608, 610, and 612. For each app, the user interface 600 indicates the type of device(s) on which portions of the app are executed (e.g., baremetal 614, Exadata 616, or other types 618). Additionally, the user interface 600 indicates the methods by which energy consumption is determined for each portion of the device types (e.g., estimated energy consumption 620, actual energy consumption 622, or calculated energy consumption 624). Further, the user interface 600 indicates the data centers 626 and 628 with which the elements of the user interface 600 are associated.

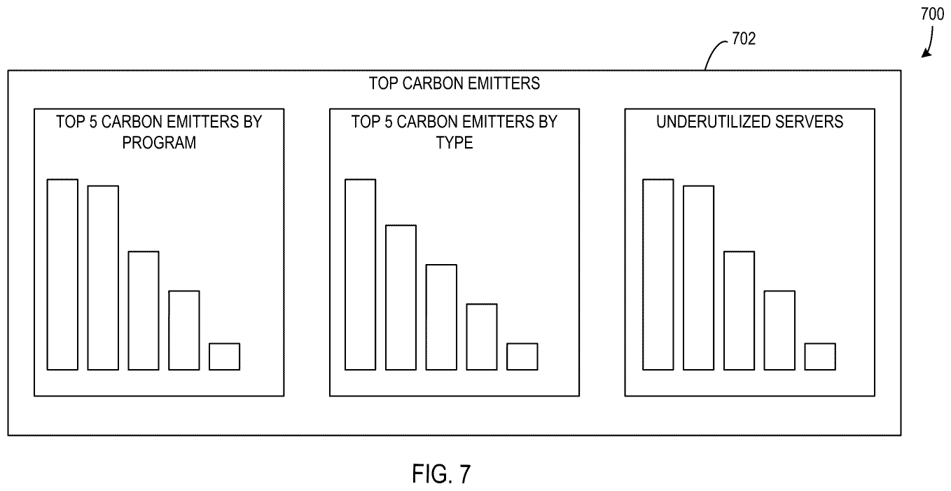

FIG. 7 illustrates an example user interface 700 for displaying 702 top carbon emitters (e.g., top 5 by program and type) and for identifying underutilized servers (e.g., number of servers by percentage CPU utilization). In some examples, a predefined number (e.g., five) of top carbon emitters or energy consumers are displayed in a user interface such as the user interface 700.

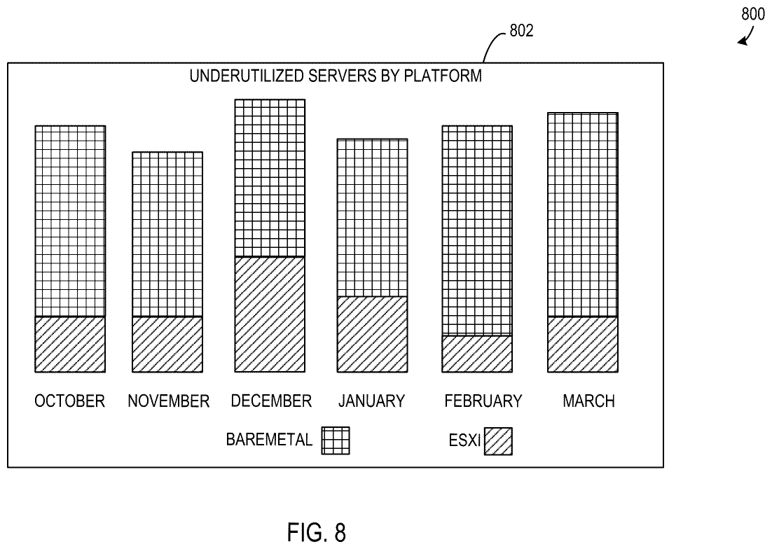

FIG. 8 illustrates an example user interface 800 for displaying 802 number of underutilized servers. In some examples, the user interface 800 displays underutilized servers of multiple different types (e.g., baremetal servers and ELASTIC SKY X integrated (ESXi) servers). For example, the number of servers with a monthly average CPU utilization of less than 35% is displayed (e.g., for last six months).

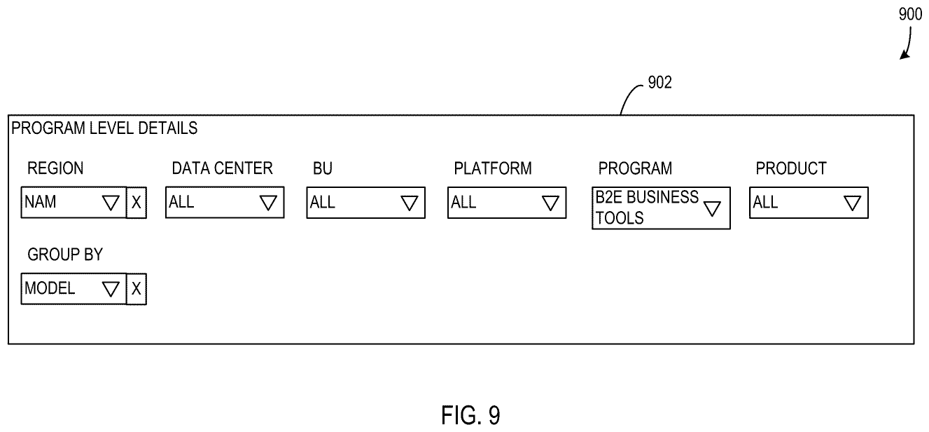

FIG. 9 illustrates an example user interface 900 for inputting program level details 902 such as region, data center, business unit (BU), platform, program, product, and how the output is grouped by (e.g., by model in the selected program) for which insights are shown.

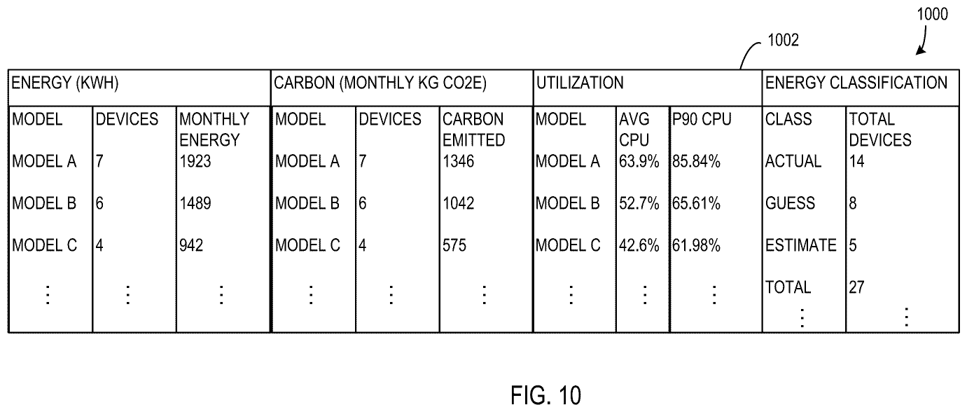

FIG. 10 illustrates an example user interface 1000 for displaying underlying data (e.g., in a tabular form 1002) used for energy, carbon emitted, utilization, and energy classification by devices.

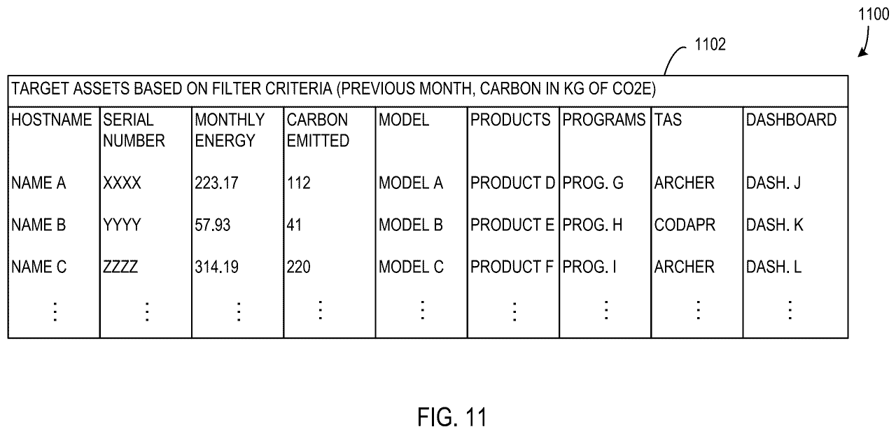

FIG. 11 illustrates an example user interface 1100 for displaying underlying data (e.g., in a tabular form 1102) used for controlling assets of a data center for ESG compliance. In other examples, more, fewer, or different types of data are included in the displayed table without departing from the description.

In some examples, service level accounting emissions are handled for each customer. For example, an action may be initiated based on measurements of energy consumption and/or CO2e cost for cross border transaction processing or for small business entity payment processing.

In some examples, if a physical asset is tagged for decommissioning, the asset may be required to be physically removed from the data center or the asset may be automatically powered off. However, if the asset is a virtual asset (e.g., an application), the asset may be automatically removed from the data center (e.g., such as by disabling the application, uninstalling the application, and the like).

In some examples, a physical server with low load utilization, and having defined thresholds (e.g., memory, speed, etc.) is virtualized. First, another server that meets the criteria of the physical server is identified. Upon identification of the other server, workflow for virtualization of the server with low load utilization is kicked off. Some examples also enable automating shutdowns of the servers. For example, if the system finds servers that often run in one city, the system shutdowns one or more servers (e.g., all or 50% of the servers) in other cities. This eliminates the redundant servers present in some cities where they are not accessed.

### Exemplary Operating Environment

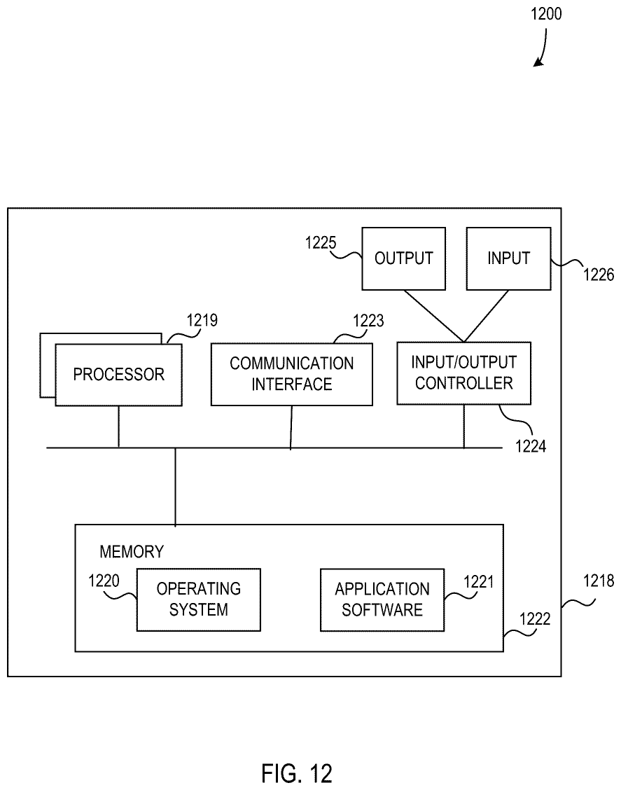

The present disclosure is operable with a computing apparatus according to an embodiment as a functional block diagram 1200 in FIG. 12. In an example, components of a computing apparatus 1218 are implemented as a part of an electronic device according to one or more embodiments described in this specification. The computing apparatus 1218 comprises one or more processors 1219 which may be microprocessors, controllers, or any other suitable type of processors for processing computer executable instructions to control the operation of the electronic device. Alternatively, or in addition, the processor 1219 is any technology capable of executing logic or instructions, such as a hard-coded machine. In some examples, platform software comprising an operating system 1220 or any other suitable platform software is provided on the apparatus 1218 to enable application software 1221 to be executed on the device. In some examples, the data process for ESG compliance of assets of a data center as described herein is accomplished by software, hardware, and/or firmware.

In some examples, computer executable instructions are provided using any computer-readable media that is accessible by the computing apparatus 1218. Computer-readable media include, for example, computer storage media such as a memory 1222 and communications media. Computer storage media, such as a memory 1222, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media embody computer readable instructions, data structures, program modules, or the like in a modulated data signal, such as a carrier wave, or other transport mechanism. As defined herein, computer storage media does not include communication media. Therefore, a computer storage medium does not include a propagating signal. Propagated signals are not examples of computer storage media. Although the computer storage medium (the memory 1222) is shown within the computing apparatus 1218, it will be appreciated by a person skilled in the art, that, in some examples, the storage is distributed or located remotely and accessed via a network or other communication link (e.g., using a communication interface 1223).

Further, in some examples, the computing apparatus 1218 comprises an input/output controller 1224 configured to output information to one or more output devices 1225, for example a display or a speaker, which are separate from or integral to the electronic device. Additionally, or alternatively, the input/output controller 1224 is configured to receive and process an input from one or more input devices 1226, for example, a keyboard, a microphone, or a touchpad. In one example, the output device 1225 also acts as the input device. An example of such a device is a touch sensitive display. The input/output controller 1224 may also output data to devices other than the output device, e.g., a locally connected printing device. In some examples, a user provides input to the input device(s) 1226 and/or receives output from the output device(s) 1225.

The functionality described herein can be performed, at least in part, by one or more hardware logic components. According to an embodiment, the computing apparatus 1218 is configured by the program code when executed by the processor 1219 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain a list of assets of a data center; measure energy consumption by assets in the list of assets during a time period; receive total energy consumption of the data center during the time period; compare the energy consumption by the assets in the list of assets with the total energy consumption of the data center during the time period; based on the comparison, determine that the total energy consumption of the data center is more than the energy consumption by the assets in the list of assets; based on the determination, identify an asset of the data center not in the list of assets; and automatically perform an action on the identified asset of the data center.

An example computerized method comprises obtaining a list of assets of a data center; measuring energy consumption by each asset in the list of assets; identifying a geographical location of each asset in the list of assets; for each asset: determining scope 2 carbon dioxide emission (CO2e) by combining emission factors associated with the identified geographical location and the measured energy consumption; and determining a cost for the determined scope 2 CO2e; identifying an asset in the list of assets having the determined cost more than a threshold value; and automatically performing an action on the identified asset in the list of assets.

A computer storage medium has computer-executable instructions that, upon execution by a processor, cause the processor to at least: obtain a list of assets of a data center; measure energy consumption by assets in the list of assets during a time period; receive total energy consumption of the data center during the time period; compare the energy consumption by the assets in the list of assets with the total energy consumption of the data center during the time period; based on the comparison, determine that the total energy consumption of the data center is more than the energy consumption by the assets in the list of assets; based on the determination, identify an asset of the data center not in the list of assets; and automatically perform an action on the identified asset of the data center.

Alternatively, or in addition to the other examples described herein, examples include any combination of the following:
wherein the total energy consumption is received from an energy provider.
wherein the energy consumption by each asset is measured via one of the following: an actual energy consumption, calculated energy consumption, estimated energy consumption, specification sheet of the asset, or an average of energy consumption of assets other than the asset.
wherein the action comprises one or more of the following: decommissioning the identified asset, virtualizing the identified asset, and configuring the identified asset in balanced mode.
further comprising: presenting a trend analysis of the cost associated with each asset in a user interface, the trend analysis comprising historical cost, current cost, and future cost associated with each asset.
further comprising: receiving an input from a user in the user interface to identify an underutilized asset in the data center; identifying the underutilized asset; and automatically performing the action on the identified underutilized asset.
further comprising: determining that the identified asset satisfies a criterion; and upon determining that the identified asset satisfies the criterion, automatically performing the action on the identified asset.
wherein the criterion comprises one of determining that the energy consumption by the identified asset is more than a threshold value or determining that the energy consumption by the identified asset is less than a threshold value.
wherein the criterion comprises determining that the identified asset is a virtual machine, determining that the identified asset is not running a database, or both.
wherein the action comprises one or more of the following: decommissioning the identified asset, virtualizing the identified asset, and configuring the identified asset in balanced mode.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining a list of assets of a data center; exemplary means for measuring energy consumption by assets in the list of assets during a time period; exemplary means for receiving total energy consumption of the data center during the time period; exemplary means for comparing the energy consumption by the assets in the list of assets with the total energy consumption of the data center during the time period; based on the comparison, exemplary means for determining that the total energy consumption of the data center is more than the energy consumption by the assets in the list of assets; based on the determination, exemplary means for identifying an asset of the data center not in the list of assets; and exemplary means for automatically performing an action on the identified asset of the data center.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain a list of assets of a data center;
measure energy consumption by assets in the list of assets during a time period;
receive total energy consumption of the data center during the time period;
compare the energy consumption by the assets in the list of assets with the total energy consumption of the data center during the time period;
based on the comparison, determine that the total energy consumption of the data center is more than the energy consumption by the assets in the list of assets;
based on the determination, identify an asset of the data center not in the list of assets; and
automatically perform an action on the identified asset of the data center.

2. The system of claim 1, wherein the action comprises one or more of the following: decommissioning the identified asset, virtualizing the identified asset, and configuring the identified asset in balanced mode.

3. The system of claim 1, wherein the total energy consumption is received from an energy provider.

4. The system of claim 1, wherein the energy consumption by each of the assets is measured via one of the following: an actual energy consumption, calculated energy consumption, estimated energy consumption, specification sheet of the asset, or an average of energy consumption of assets other than the asset.

5. The system of claim 1, wherein the memory and computer program code are configured to further cause the processor to:
determine that the identified asset satisfies a criterion; and
upon determining that the identified asset satisfies the criterion, automatically perform the action on the identified asset.

6. The system of claim 4, wherein the criterion comprises one of determining that the energy consumption by the identified asset is more than a threshold value or determining that the energy consumption by the identified asset is less than a threshold value.

7. The system of claim 4, wherein the criterion comprises determining that the identified asset is a virtual machine, determining that the identified asset is not running a database, or both.

8. A computerized method comprising:
obtaining a list of assets of a data center;
measuring energy consumption by each asset in the list of assets;
identifying a geographical location of each asset in the list of assets;
for each asset:
determining scope 2 carbon dioxide emission (CO2e) by combining emission factors associated with the identified geographical location and the measured energy consumption; and
determining a cost for the determined scope 2 CO2e;
identifying an asset in the list of assets having the determined cost more than a threshold value; and
automatically performing an action on the identified asset in the list of assets.

9. The computerized method of claim 8, wherein the energy consumption by each asset is measured via one of the following: an actual energy consumption, calculated energy consumption, estimated energy consumption, specification sheet of the asset, or an average of energy consumption of assets other than the asset.

10. The computerized method of claim 8, wherein the action comprises one or more of the following: decommissioning the identified asset, virtualizing the identified asset, and configuring the identified asset in balanced mode.

11. The computerized method of claim 8, further comprising:
presenting a trend analysis of the cost associated with each asset in a user interface, the trend analysis comprising historical cost, current cost, and future cost associated with each asset.

12. The computerized method of claim 11, further comprising:
receiving an input from a user in the user interface to identify an underutilized asset in the data center;
identifying the underutilized asset; and
automatically performing the action on the identified underutilized asset.

13. The computerized method of claim 8, further comprising:
determining that the identified asset satisfies a criterion; and
upon determining that the identified asset satisfies the criterion, automatically performing the action on the identified asset.

14. The computerized method of claim 13, wherein the criterion comprises determining that the identified asset is a virtual machine, determining that the identified asset is not running a database, or both.

15. A computer storage medium has computer-executable instructions that, upon execution by a processor, cause the processor to at least:
obtain a list of assets of a data center;
measure energy consumption by assets in the list of assets during a time period;
receive total energy consumption of the data center during the time period;
compare the energy consumption by the assets in the list of assets with the total energy consumption of the data center during the time period;
based on the comparison, determine that the total energy consumption of the data center is more than the energy consumption by the assets in the list of assets;
based on the determination, identify an asset of the data center not in the list of assets; and
automatically perform an action on the identified asset of the data center.

16. The computer storage medium of claim 15, wherein the total energy consumption is received from an energy provider.

17. The computer storage medium of claim 15, wherein the energy consumption by each of the assets is measured via one of the following: an actual energy consumption, calculated energy consumption, estimated energy consumption, specification sheet of the asset, or an average of energy consumption of assets other than the asset.

18. The computer storage medium of claim 15, wherein the computer-executable instructions that, execution by a processor, further cause the processor to at least:
determine that the identified asset satisfies a criterion; and
upon determining that the identified asset satisfies the criterion, automatically perform the action on the identified asset.

19. The computer storage medium of claim 18, wherein the criterion comprises one of the following: determining that the energy consumption by the identified asset is more than a threshold value or determining that the energy consumption by the identified asset is less than a threshold value.

20. The computer storage medium of claim 18, wherein the criterion comprises determining that the identified asset is a virtual machine, determining that the identified asset is not running a database, or both.
